(19) United States
(12) Patent Application Publication
(10) Pub. No.: US 2004/0243530 A1
(43) Pub. Date: Dec. 2, 2004

(54) Process-related systems and methods

(76) Inventors: Akeel Al-Attar, Manchester (GB); Simon Pressinger, Surrey (GB)

Correspondence Address: Charles W Fallow, Shoemaker and Mattare, P O Box 2286, Arlington, VA, 22202-0286, US

(21) Appl. No.: 10/482,160

(22) PCT Filed: Jul. 4, 2002
(86) PCT No.: PCT/GB02/03076

(30) Foreign Application Priority Data
Jul. 4, 2001 (GB) 0116319.5

(51) Int. Cl. G06N 5/00

(52) U.S. Cl. 706/45

(57) ABSTRACT

The present invention relates to process development systems and related methods, including a process development wsystem comprising: a performance improvement rule generation module for generating a performance improvement rule set for at least one process factor from a generated rule set for the at least one process factor, each rule including a plurality of decision points corresponding to split variables relating to process conditions and a plurality of outcomes, wherein the performance improvement rule generation module is configured, for each rule from the or each generated rule set, to attach an activity flag at each decision point and thereby generate a performance improvement rule, the activity flag having one of two values indicative of whether the respective split variable is alterable or non-alterable by a process operator such as to enable operation of the performance improvement rule in determining which of the outcomes is attainable for given process conditions.

The present invention relates to process-related systems and methods for the improvement of complex process operations.

The present invention can be applied to the analysis of a range of process operation issues, including energy usage and cost, environmental emissions, including CO₂ emissions associated with energy usage, process revenue and profit, product quality, yield, throughput/output and down-time/non-productive time.

Such issues are relevant in many sectors, including the oil, petrochemical, chemical, pharmaceutical, minerals, metals, pulp and paper, mining, powder processing, food and drink, dairy, utilities and power generation sectors.

The present invention finds particular application in the improvement of oil drilling operations, especially in reducing the likelihood of drilling operating problems, such as stuck pipe, and optimizing other key variables, such as the rate of penetration, mud temperature and torque.

The present invention also finds particular application in the improvement of oil field operations, especially in the selection of well configurations and outputs to optimize oil output and control water cut and gas oil ratios, and to optimize water injection.

The present invention further finds particular application in reducing energy usage in estates of similar buildings, especially supermarkets with significant retail refrigeration, where the influencing factors include ‘between store factors’, such as the store size, contractor used and sales volume.

The present invention yet further finds particular application in the power generation industry, especially in the improvement of efficiency and reduction of emissions.

The present invention still further finds particular application in the powder and cement manufacturing industries, especially in the improvement of yield and quality.

In one aspect the present invention provides a process development system, comprising: a performance improvement rule generation module for generating a performance improvement rule set for at least one process factor from a generated rule set for the at least one process factor, each rule including a plurality of decision points corresponding to split variables relating to process conditions and a plurality of outcomes, wherein the performance improvement rule generation module is configured, for each rule from the or each generated rule set, to attach an activity flag at each decision point and thereby generate a performance improvement rule, the activity flag having one of two values indicative of whether the respective split variable is alterable or non-alterable by a process operator such as to enable operation of the performance improvement rule in determining which of the outcomes is attainable for given process conditions.

Preferably, the or each rule is represented as a decision tree having a plurality of internal nodes and a plurality of terminal nodes, with the decision points being the internal nodes and the outcomes being the terminal nodes.

Preferably, the system further comprises: a rule generation module for generating the generated rule set for the at least one process factor by applying rule induction techniques to a rule-generation data set including data corresponding to process conditions.

More preferably, the system further comprises: a data collection module for collecting historic process data and deriving the rule-generation data set from the historic process data.

Yet more preferably, the data collection module is configured to derive the rule-generation data set and an extracted data set, unseen by the rule generation module, from the historic process data.

Preferably, the system further comprises: a rule verification module for verifying the generated rule set for the at least one process factor.

More preferably, the rule verification module comprises a rule test sub-module which utilizes the extracted data set to satisfy that each rule is satisfied by the extracted data set.

Preferably, the rule verification module comprises a rule modification sub-module for enabling the rule generation module to be re-invoked to generate a modified generated rule set for the at least one process factor.

Preferably, the system further comprises: a rule condition attachment module for attaching to any rule at least one process condition having an associated range such that the respective rule is satisfied only where the at least one process condition is also within the associated range.

Preferably, the system further comprises: a constraint definition module for setting non-violable limiting constraints to at least one process condition such as to require a value of the at least one process condition to satisfy the limiting constraints.

Preferably, the system further comprises: a performance improvement determination module for determining process control improvements based on at least one of the at least one performance improvement rule set, the performance improvement determination module being configured to determine, for any rule and given process conditions, which of the outcomes is attainable based on the values of the activity flags.

In one embodiment the given process conditions are historic process conditions, thereby enabling a best-value outcome to be determined for the historic process conditions.

In another embodiment the system further comprises: a data logging module for logging real-time process conditions from a process system; and wherein the given process conditions are ones of the logged real-time process conditions, thereby enabling a determination of optimal process conditions.

Preferably, the performance improvement determination module is configured to provide process control improvements to be applied to a process system, in one embodiment by proposing process improvements to a process operator.

In another aspect the present invention provides a process development system, comprising: a performance improvement determination module for determining process control improvements based on at least one performance improvement rule set for at least one process factor, each rule including a plurality of decision points corresponding to split variables relating to process conditions, a plurality of outcomes and an activity flag at each decision point, the activity flag having one of two values indicative of whether the respective split variable is alterable or non-alterable by a process operator, wherein the performance improvement determination module is configured to determine, for any rule and given process conditions, which of the outcomes is attainable based on the values of the activity flags.

Preferably, the or each rule is represented as a decision tree having a plurality of internal nodes and a plurality of terminal nodes, with the decision points being the internal nodes and the outcomes being the terminal nodes.

In one embodiment the given process conditions are historic process conditions, thereby enabling a best-value outcome to be determined for the historic process conditions.

In another embodiment the system further comprises: a data logging module for logging real-time process conditions from a process system; and wherein the given process conditions are ones of the logged real-time process conditions, thereby enabling a determination of optimal process conditions.

Preferably, the performance improvement determination module is configured to provide process control improvements to be applied to a process system, in one embodiment by proposing process improvements to a process operator.

In a further aspect the present invention provides a process development method, comprising the steps of: generating a performance improvement rule set for at least one process factor from a generated rule set for the at least one process factor, each rule including a plurality of decision points corresponding to split variables relating to process conditions and a plurality of outcomes, the performance improvement rule generation step comprising the step of: for each rule from the or each generated rule set, attaching an activity flag at each decision point to generate a performance improvement rule, the activity flag having one of two values indicative of whether the respective split variable is alterable or non-alterable by a process operator such as to enable operation of the performance improvement rule in determining which of the outcomes is attainable for given process conditions.

Preferably, the or each rule is represented as a decision tree having a plurality of internal nodes and a plurality of terminal nodes, with the decision points being the internal nodes and the outcomes being the terminal nodes.

Preferably, the method further comprises the step of: generating the generated rule set for the at least one process factor by applying rule induction techniques to a rule-generation data set including data corresponding to process conditions.

More preferably, the method further comprises the step of: collecting historic process data and deriving the rule-generation data set from the historic process data.

Yet more preferably, the historic process data collection step comprises the step of: deriving the rule-generation data set and an extracted data set, unseen in generation of the generated rule set, from the historic process data.

Preferably, the method further comprises the step of: verifying the generated rule set for the at least one process factor.

More preferably, the generated rule set verification step comprises the step of: testing the generated rule set by utilizing the extracted data set to satisfy that each rule is satisfied by the extracted data set.

Preferably, the generated rule set verification step comprises the step of: re-invoking the rule set generation step to generate a modified generated rule set for the at least one process factor.

Preferably, the method further comprises the step of: attaching to any rule at least one process condition having an associated range such that the respective rule is satisfied only where the at least one process condition is also within the associated range.

Preferably, the method further comprises the step of: setting non-violable limiting constraints to at least one process condition such as to require a value of the at least one process condition to satisfy the limiting constraints.

Preferably, the method further comprises the step of: determining process control improvements based on at least one of the at least one performance improvement rule set, the process control improvements determining step comprising the step of: determining, for any rule and given process conditions, which of the outcomes is attainable based on the values of the activity flags.

In one embodiment the given process conditions are historic process conditions, thereby enabling a best-value outcome to be determined for the historic process conditions.

In another embodiment the method further comprises the step of: logging real-time process conditions from a process system; and wherein the given process conditions are ones of the logged real-time process conditions, thereby enabling a determination of optimized process conditions.

Preferably, the process control improvements determining step further comprises the step of: providing process control improvements to be applied to a process system, in one embodiment proposing process improvements to a process operator.

In a yet further aspect the present invention provides a process development method, comprising the steps of: determining process control improvements based on at least one performance improvement rule set for at least one process factor, each rule including a plurality of decision points corresponding to split variables relating to process conditions, a plurality of outcomes and an activity flag at each decision point, the activity flag having one of two values indicative of whether the respective split variable is alterable or non-alterable by a process operator, wherein the process control improvements determining step comprises the step of: determining, for any rule and given process conditions, which of the outcomes is attainable based on the values of the activity flags.

Preferably, the or each rule is represented as a decision tree having a plurality of internal nodes and a plurality of terminal nodes, with the decision points being the internal nodes and the outcomes being the terminal nodes.

In one embodiment the given process conditions are historic process conditions, thereby enabling a best-value outcome to be determined for the historic process conditions.

In another embodiment the method further comprises the step of: logging real-time process conditions from a process system; and wherein the given process conditions are ones of the logged real-time process conditions, thereby enabling a determination of optimized process conditions.

Preferably, the process control improvements determining step further comprises the step of: providing process control improvements to be applied to a process system, in one embodiment proposing process improvements to a process operator.

A preferred embodiment of the present invention will now be described hereinbelow by way of example only with reference to the accompanying drawings, in which:

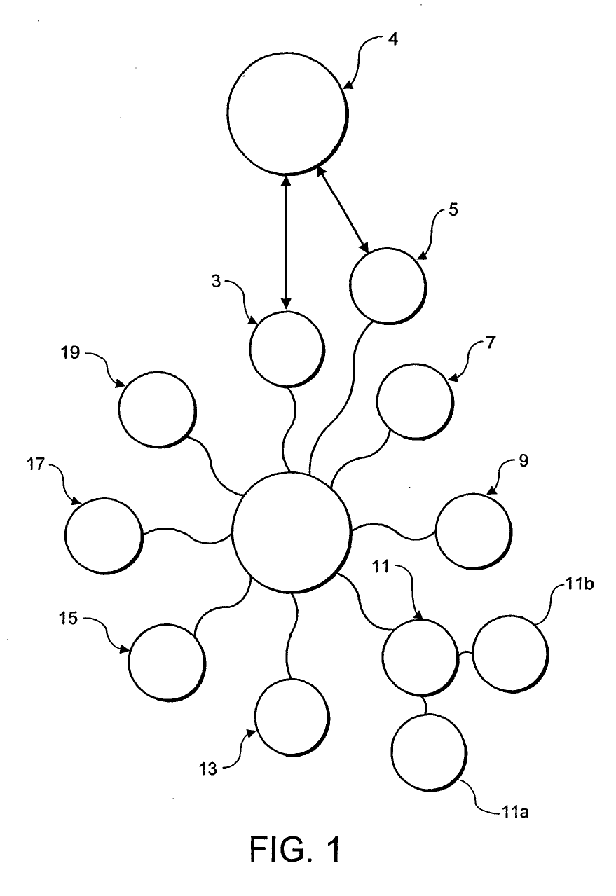

FIG. 1 schematically illustrates a process development system in accordance with a preferred embodiment of the present invention;

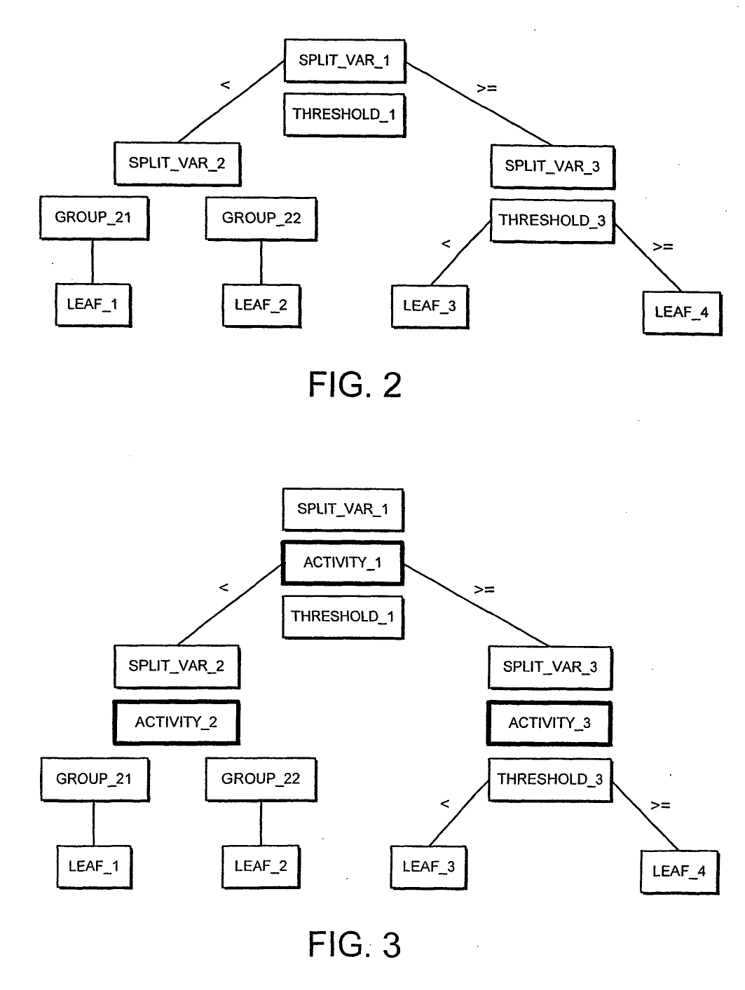

FIG. 2 illustrates an exemplary decision tree as developed by the rule generation module of the system of FIG. 1; and

FIG. 3 illustrates an exemplary modified decision tree, as a modification of the decision tree of FIG. 2, as developed by the performance improvement rule generation module of the system of FIG. 1.

The system comprises a historic data collection module 3 for collecting historic data as obtained from a process system 4. In this embodiment the data collection module 3 is configured to download data from one or more storage locations, typically databases, but in other embodiments the data could be transferred using a storage medium.

In the development of the process system, critical success factors (CSFs) are identified as critical parameters to the performance of the process. Typical CSFs include operating costs, revenue, profit, throughput, yield, unit efficiency, energy usage, emissions, product quality, plant reliability and maintenance.

In the collected historic data, influencing factors (IFs) are identified as parameters which can influence the CSFs, typical IFs including flow rates, temperatures, pressures, control set points and external influencers, such as ambient conditions. As will be described in more detail hereinbelow, IFs are characterized as either ‘active’ variables which are alterable process variables, or ‘inactive’ variables which are disturbances and outside the control of a process operator.

In a preferred embodiment the collected historic data is data which has been logged at a frequency at least twice that of significant changes in the CSFs and IFs, and which encompasses an extended period of operation, typically six months.

In this embodiment a sub-set of the collected historic data for one or more time periods is extracted from the collected data to provide an extracted data set to allow for rule testing as will be described in more detail hereinbelow, with the remaining data providing an operable, main data set.

The system further comprises a data logging module 5 for logging data from the process system 4, the data including at least the IFs and other events, such as the actions of a process operator. In a preferred embodiment the data is logged in real-time, but in an alternative embodiment the data logging could be delayed.

The system further comprises a data modification module 7 for enabling the main data set to be checked for errors and altered in response thereto, for example, by deleting bad records and making corrections, and determining further candidate IFs from the main data set, such as ratios of flows, overall heat transfer coefficients, average values, data variance and standard deviations.

The system further comprises a rule generation module 9 which utilizes rule induction techniques having associated rule induction parameters to identify patterns in the main data set for each CSF. The identified patterns are expressed as rules, depictable as decision trees, which define, in whole or in part, the variation in the respective CSF, and together define a rule set.

Merely by way of example, one such rule could be expressed as:

If IF1 (e.g. ambient temperature)>A

And IF2 (e.g. wind speed)<B

And IF3 (e.g. temperature set point)>C

Then CSF (process revenue)=D

The system further comprises a rule verification module 11 for verifying the rules of the determined rule set.

In this embodiment the rule verification module 11 includes a rule test sub-module 11a which utilizes the extracted data set which was not utilized in generating the determined rules, with the rules being verified by determining that each rule is satisfied by the data of the extracted data set. Where any of the rules is not satisfied, the rule generation module 9 can be re-invoked to utilize one or both of modified rule induction techniques and rule induction parameters.

In this embodiment the rule verification module 11 further includes a rule modification sub-module 11b which allows the rule generation module 9 to be re-invoked to utilize one or both of modified rule induction techniques and rule induction parameters where a modified rule set is required, for example, because of process conditions envisageable by a process operator.

The system further comprises a rule condition attachment module 13 which, for any determined rule, enables one or more IFs, referred to as significant influencing factors (SIFs), which can be the IFs utilized in defining the particular rule, to be attached to that rule with an associated range, such that the rule is satisfied only where the one or more SIFs are also within the associated range.

By providing for the attachment of SIFs, which have an associated range, to the rules, a further measure of confidence is provided in the rule set. In this embodiment the limits of the ranges associated to the SIFs are defined as the minimum and maximum values in the relevant sub-set of data in the main data set.

In this embodiment the rule verification module 11 is re-invoked for a modified rule set. Where any of the rules is not satisfied, one of the rule condition attachment module 13 or the rule generation module 9 can be re-invoked. Where the rule condition attachment module 13 is re-invoked, limits of the ranges associated to the SIFs attached at least to the failed rules are altered. Where the rule generation module 9 is re-invoked, one or both of modified rule induction techniques and rule induction parameters are utilized.

The system further comprises a constraint definition module 15 for setting non-violable limiting constraints to one or more of the IFs. In this embodiment the limiting constraints are defined using ‘tree models’ and process-specific functions.

The system further comprises a performance improvement rule (PIR) generation module 17 for generating performance improvement rules (PIRs) from the determined rule set, where taking into account the non-violable limiting constraints set for any of the IFs. In this embodiment the PIRs are derived from decision trees for the rules of the determined rule set.

FIG. 2 illustrates a decision tree depicting an exemplary rule. It should be appreciated that this rule is provided merely by way of exemplification.

At each internal node in the decision tree, a split variable SPLIT_VAR_X corresponding to an IF is compared with either a threshold value THRESHOLD_X in the case of a continuous numeric variable, or a sub-set of discrete values GROUP_XN in the case of a discrete variable, and the direction of branching is decided according to the logical outcome at the node. Each terminal.node LEAF_X represents a particular outcome leaf, that is, a CSF, and has an associated set of average values for the IFs, that is, both the split variable IFs and the other, non-split variable IFs, and the CSF. The average values for the IFs and the CSF are determined from the sub-set of data in the main data set which corresponds to the particular outcome leaf LEAF_X.

A logical activity flag ACTIVITY_X is attached to each internal node of the decision tree, which activity flag ACTIVITY_X is indicative as to whether the split variable SPLIT_VAR_X is an ‘active’ variable, that is, a variable which can be altered, or an ‘inactive’ variable, that is, a disturbance which cannot be altered by a process operator. Where any split variable SPLIT_VAR_X is an ‘active’ variable, the associated threshold value THRESHOLD_X or discrete values GROUP_XN can be forced to have different values as may be desired to force a particular, more optimal outcome leaf LEAF_X. FIG. 3 illustrates the exemplified decision tree where modified to include an activity flag ACTIVITY_X at each internal node.

Each activity flag ACTIVITY_X is then set, with the activity flag ACTIVITY_X being set to logical ‘TRUE’ where the respective split variable SPLIT_VAR_X is an ‘active’ variable and logical ‘FALSE’ where the respective split variable SPLIT_VAR_X is an ‘inactive’ variable.

The resulting rule is a performance improvement rule which is utilized for process analysis and control, as will be described in more detail hereinbelow.

In one alternative embodiment the value of the CSF at each outcome leaf LEAF_X can be determined by regression analysis using the sub-set of data in the main data set at the outcome leaf LEAF_X and the IFs as regression variables, but it should be understood that such determination of the CSF values is optional.

The system further comprises a performance improvement determination module 19 for determining process control improvements based on the performance improvement rule sets.

For a particular CSF and a particular set of values of the IFs, which provide inter alia the split variable values SPLIT_VAR_X of a respective performance improvement rule, one outcome leaf LEAF_X is identified; this outcome leaf LEAF_X being determined from the logical outcome at each internal node.

Each split variable value SPLIT_VAR_X is then logically ‘OR’ed with the respective activity flag ACTIVITY_X such as to determine, for the particular set of values of the IFs, whether the other logical outcome can be forced at each internal node, and, from this determination, determine each candidate outcome leaf LEAF_X.

For each candidate outcome leaf LEAF_X, a check is then performed to determine that no constraint limits for the IFs are violated by forcing the other logical outcome at the internal nodes relevant for the candidate outcome leaf LEAF_X. Where no constraint limit is violated, the candidate outcome leaf LEAF_X is identified as an attainable outcome leaf LEAF_X The constraint limits are tested using a combination of the current values of the IFs, which provide inter alia the split variable values SPLIT_VAR_X, and the values of the controllable split variable values SPLIT_VAR_X which have to be forced to reach the candidate outcome leaf LEAF_X.

For each attainable outcome leaf LEAF_X, the outcome, that is, the value of the CSF, as represented typically by an average value, is determined, and an optimal outcome leaf LEAF_X identified as providing a best-value outcome.

In one embodiment, for collected historic data as collected by the historic data collection module 3, the values of the IFs, which provide inter alia the split variable values SPLIT_VAR_X and are used to determine an optimal outcome leaf LEAF_X, correspond to the data at each logged time interval, thereby enabling a best-value outcome to be determined for each time interval. In this way, a process operator can be presented with comprehensive information as to the scope of the achievable benefit of the process improvement based over an extended time period, which information can include the process improvements which the system would have proposed had the system been in operation.

In another embodiment, for real-time data as logged by the data logging module 5, the values of the IFs, which provide inter alia the split variable values SPLIT_VAR_X and are used to determine an optimal outcome leaf LEAF_X, correspond to actual real-time data from the process system 4, thereby enabling a determination of optimal process conditions and a quantification of the benefit achievable, which optimization can either be implemented automatically or proposed to a process operator as a process improvement. In one embodiment the data logging module 5 and the performance improvement determination module 19 can be deployed at the process system 4 to allow for on-site operation.

The performance improvement determination module 19 finds particular application as a ‘what if’ tool which can be used as an investigative tool, for example, by engineers and managers, to investigate the impact of changes in the IFs, the settings of the activity flags ACTIVITY_X of the split variable IFs, the range limits for any SIFs and any limiting constraints of the IFs on the CSFs.

The performance improvement determination module 19 also finds particular application within an on-line performance monitoring system which is integrated into a process control system to alert a process operator to deviation from expected performance in a timely manner, which deviation typically would be indicative of a fault.

The performance improvement determination module 19 further finds particular application in reporting actual and expected CSFs, typically at periodic intervals, for example, hourly, daily, weekly, monthly or annually, as part of a process performance management system, and similarly the results of the analysis of the actions of the operations staff.

In this embodiment the modules of the system are implemented in software tools in a computer-based platform.

Finally, it will be understood that the present invention has been described in its preferred embodiments and can be modified in many different ways without departing from the scope of the invention as defined by the appended claims.

1. A process development system, comprising:
a performance improvement rule generation module for generating a performance improvement rule set for at least one process factor from a generated rule set for the at least one process factor, each rule of the or each generated rule set including a plurality of decision points corresponding to split variables relating to process conditions and a plurality of outcomes, wherein the performance improvement rule generation module is configured, for each rule from the or each generated rule set, to attach an activity flag at each decision point and thereby generate a performance improvement rule, each activity flag having one of two values indicative of whether the respective split variable is alterable or non-alterable by a process operator or an automated process control system, such as to enable operation of the performance improvement rule in determining which of the outcomes is attainable for given process conditions.

2. The system of claim 1, wherein the or each rule is represented as a decision tree having a plurality of internal nodes and a plurality of terminal nodes, with the decision points being the internal nodes and the outcomes being the terminal nodes.

3. The system of claim 1, further comprising:
a rule generation module for generating the generated rule set for the at least one process factor by applying rule induction techniques to a rule-generation data set including data corresponding to process conditions.

4. The system of claim 3, further comprising:
a data collection module for collecting historic process data and deriving the rule-generation data set from the historic process data.

5. The system of claim 4, wherein the data collection module is configured to derive the rule-generation data set and an extracted data set, unseen by the rule generation module, from the historic process data.

6. The system of claim 3, further comprising:
a rule verification module for verifying the generated rule set for the at least one process factor.

7. The system of claim 6, further comprising:
a data collection module for collecting historic process data and deriving the rule-generation data set and an extracted data set, unseen by the rule generation module, from the historic process data: and
wherein the rule verification module comprises a rule test sub-module which utilizes the extracted data set to satisfy that each rule is satisfied by the extracted data set.

8. The system of claim 6, wherein the rule verification module comprises a rule modification sub-module for enabling the rule generation module to be re-invoked to generate a modified generated rule set for the at least one process factor.

9. The system of claim 1, further comprising:
a rule condition attachment module for attaching to any rule at least one process condition having an associated range such that the respective rule is satisfied only where the at least one process condition is also within the associated range.

10. The system of claim 1, further comprising:
a constraint definition module for setting non-violable limiting constraints to at least one process condition such as to require a value of the at least one process condition to satisfy the limiting constraints.

11. The system of claim 1, further comprising:
a performance improvement determination module for determining process control improvements based on at least one of the at least one performance improvement rule set, the performance improvement determination module being configured to determine, for any rule and given process conditions, which of the outcomes is attainable based on the values of the activity flags.

12. The system of claim 11, wherein the given process conditions are historic process conditions, thereby enabling a best-value outcome to be determined for the historic process conditions.

13. The system of claim 11, further comprising:
a data logging module for logging real-time process conditions from a process system; and
wherein the given process conditions are ones of the logged real-time process conditions, thereby enabling a determination of optimal process conditions.

14. The system of claim 13, wherein the performance improvement determination module is configured to provide process control improvements to be applied to a process system.

15. A process development system, comprising:
a performance improvement determination module for determining process control improvements based on at least one performance improvement rule set for at least one process factor, each rule of a performance improvement rule set including a plurality of decision points corresponding to split variables relating to process conditions a plurality of outcomes and an activity flag at each decision point, each activity flag having one of two values indicative of whether the respective split variable is alterable or non-alterable by a process operator or an automated process control system, wherein the performance improvement determination module is configured to determine, for any rule and given process conditions, which of the outcomes is attainable based on the values of the activity flags.

16. The system of claim 15, wherein the or each rule is represented as a decision tree having a plurality of internal nodes and a plurality of terminal nodes, with the decision points being the internal nodes and the outcomes being the terminal nodes.

17. The system of claim 15, wherein the given process conditions are historic process conditions, thereby enabling a best-value outcome to be determined for the historic process conditions.

18. The system of claim 15, further comprising:
a data logging module for logging real-time process conditions from a process system; and
wherein the given process conditions are ones of the logged real-time process conditions, thereby enabling a determination of optimal process conditions.

19. The system of claim 18, wherein the performance improvement determination module is configured to provide process control improvements to be applied to a process system.

20. A process development method, comprising the steps of:
generating a performance improvement rule set for at least one process factor from a generated rule set for the at least one process factor, each rule of the or each generated rule set including a plurality of decision points corresponding to split variables relating to process conditions and a plurality of outcomes, the performance improvement rule generation step comprising the step of: for each rule from the or each generated rule set, attaching an activity flag at each decision point to generate a performance improvement rules each activity flag having one of two values indicative of whether the respective split variable is alterable or non-alterable by a process operator or an automated process control system, such as to enable operation of the performance improvement rule in determining which of the outcomes is attainable for given process conditions.

21. The method of claim 20, wherein the or each rule is represented as a decision tree having a plurality of internal nodes and a plurality of terminal nodes, with the decision points being the internal nodes and the outcomes being the terminal nodes.

22. The method of claim 20, further comprising the step of:
generating the generated rule set for the at least one process factor by applying rule induction techniques to a rule-generation data set including data corresponding to process conditions.

23. The method of claim 22, further comprising the step of:
collecting historic process data and deriving the rule-generation data set from the historic process data.

24. The method of claim 23, wherein the historic process data collection step comprises the step of:
deriving the rule-generation data set and an extracted data set, unseen in generation of the generated rule set, from the historic process data.

25. The method of claim 22, further comprising the step of:
verifying the generated rule set for the at least one process factor.

26. The method of claim 25, further comprising the step of collecting historic process data and deriving the rule-generation data set and an extracted data set, unseen in generation of the generated rule set from the historic process data, and
wherein the generated rule set verification step comprises the step of:
testing the generated rule set by utilizing the extracted data set to satisfy that each rule is satisfied by the extracted data set.

27. The method of claim 25, wherein the generated rule set verification step comprises the step of:
re-invoking the rule set generation step to generate a modified generated rule set for the at least one process factor.

28. The method of claim 20, further comprising the step of:
attaching to any rule at least one process condition having an associated range such that the respective rule is satisfied only where the at least one process condition is also within the associated range.

29. The method of claim 20, further comprising the step of:
setting non-violable constraints to at least one process condition such as to require a value of the at least one process condition to satisfy the limiting constraints.

30. The method of claim 20, further comprising the step of:
determining process control improvements based on at least one of the at least one performance improvement rule set, the process control improvements determining step comprising the step of:
determining, for any rule and given process conditions, which of the outcomes is attainable based on the values of the activity flags.

31. The method of claim 30, wherein the given process conditions are historic process conditions, thereby enabling a best-value outcome to be determined for the historic process conditions.

32. The method of claim 30, further comprising the step of:
logging real-time process conditions from a process system; and
wherein the given process conditions are ones of the logged real-time process conditions, thereby enabling a determination of optimized process conditions.

33. The method of claim 32, wherein the process control improvements determining step further comprises the step of:
providing process control improvements to be applied to a process system.

34. A process development method, comprising the steps of:
determining process control improvements based on at least one performance improvement rule set for at least one process factor, each rule of a performance improvement rule set including a plurality of decision points corresponding to split variables relating to process conditions, a plurality of outcomes and an activity flag at each decision point, each activity flag having one of two values indicative of whether the respective split variable is alterable or non-alterable by a process operator or an automated process control system, wherein the process control improvements determining step comprises the step of:
determining, for any rule and given process conditions, which of the outcomes is attainable based on the values of the activity flags.

35. The method of claim 34, wherein the or each rule is represented as a decision tree having a plurality of internal nodes and a plurality of terminal nodes, with the decision points being the internal nodes and the outcomes being the terminal nodes.

36. The method of claim 34, wherein the given process conditions are historic process conditions, thereby enabling a best-value outcome to be determined for the historic process conditions.

37. The method of claim 34, further comprising the step of:
logging real-time process conditions from a process system; and
wherein the given process conditions are ones of the logged real-time process conditions, thereby enabling a determination of optimized process conditions.

38. The method of claim 37, wherein the process control improvements determining step further comprises the step of:
providing process control improvements to be applied to a process system.
